(19) United States
(12) Patent Application Publication
(10) Pub. No.: US 2022/0141174 A1
(43) Pub. Date: May 5, 2022

(54) METHOD AND SYSTEM FOR SELECTING MULTIPLE TARGET NODES WITHIN SOCIAL NETWORK

(71) Applicant: NATIONAL TSING HUA UNIVERSITY, HSINCHU (TW)

(72) Inventor: Wei-Chang YEH, Hsinchu (TW)

(21) Appl. No.: 17/230,953

(22) Filed: Apr. 14, 2021

(30) Foreign Application Priority Data
Nov. 3, 2020 (TW) 109138315

(51) Int. Cl. H04L 12/58; H04L 12/24

(52) U.S. Cl. CPC H04L 51/32; H04L 41/145

(57) ABSTRACT

A method for selecting multiple target nodes within a social network includes a selecting step, a simulation passing node number calculating step and a target node updating step. The selecting step is performed to select a plurality of simulation nodes from a plurality of nodes in the social network according to a simplified swarm forming rule. The simulation passing node number calculating step is performed to calculate a simulation passing node number of the simulation nodes according to a Monte Carlo simulation method and a layer search method. The target node updating step is performed to update the simulation nodes and the simulation passing node number as the target nodes and the target passing node number according to a simplified swarm updating rule, respectively.

### RELATED APPLICATIONS

This application claims priority to Taiwan Application Serial Number 109138315, filed Nov. 3, 2020, which is herein incorporated by reference.

### BACKGROUND

### Technical Field

The present disclosure relates to a method and a system for selecting target node. More particularly, the present disclosure relates to a method and a system for selecting multiple target nodes within a social network.

### Description of Related Art

Social network is widespread because of the development of the technology. The social network has become a main medium of transmitting message. However, the traditional selecting method and system for putting message need huge computation, effort and cost. Thus, a method and a system for selecting multiple target nodes within the social network which are capable of putting message to less target nodes to achieve a great passing efficient within the social network are commercially desirable.

### SUMMARY

According to one aspect of the present disclosure, a method for selecting multiple target nodes within a social network is performed to put a message to the target nodes in the social network to achieve a target passing node number. The method for selecting multiple target nodes within the social network includes a selecting step, a simulation passing node number calculating step and a target node updating step. The selecting step is performed to select a plurality of simulation nodes from a plurality of nodes in the social network according to a simplified swarm forming rule. The simulation passing node number calculating step is performed to calculate a simulation passing node number of the simulation nodes according to a Monte Carlo simulation method and a layer search method. The target node updating step is performed to update the simulation nodes and the simulation passing node number as the target nodes and the target passing node number according to a simplified swarm updating rule, respectively. In response to determining that the simulation passing node number is smaller than the target passing node number, the selecting step, the simulation passing node number calculating step and the target node updating step are performed again.

According to another aspect of the present disclosure, a system for selecting multiple target nodes within a social network is configured to put a message to the target nodes in the social network to achieve a target passing node number. The system for selecting multiple target nodes within the social network includes a memory and a processor. The memory accesses a plurality of nodes of the social network. The processor is electrically connected to the memory. The processor receives the nodes and is configured to implement a method for selecting multiple target nodes within the social network including performing a selecting step, a simulation passing node number calculating step and a target node updating step. The selecting step is performed to select a plurality of simulation nodes from the nodes in the social network according to a simplified swarm forming rule. The simulation passing node number calculation step is performed to calculate a simulation passing node number of the simulation nodes according to a Monte Carlo simulation method and a layer search method. The target node updating step is performed to update the simulation nodes and the simulation passing node number as the target nodes and the target passing node number according to a simplified swarm updating rule, respectively. In response to determining that the simulation passing node number is smaller than the target passing node number, the selecting step, the simulation passing node number calculating step and the target node updating step are performed again.

### BRIEF DESCRIPTION OF THE DRAWINGS

The present disclosure can be more fully understood by reading the following detailed description of the embodiment, with reference made to the accompanying drawings as follows:

FIG. 1 shows a flow chart of a method for selecting multiple target nodes within a social network according to an embodiment of the present disclosure.

FIG. 2 shows a flow chart of the selecting step of FIG. 1.

FIG. 3 shows a flow chart of the simulation passing node number calculating step of FIG. 1.

FIG. 4 shows a schematic view of a feasible passing model of the propagating probability verifying step of FIG. 3.

FIG. 5 shows a schematic view of the layer searching step of FIG. 3.

FIG. 6 shows a block diagram of a system for selecting multiple target nodes within a social network according to another embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “connected to” another element, it can be directly connected to other element, or it can be indirectly connected to the other element, that is, intervening elements may be present. In contrast, when an element is referred to as be “directly connected to” another element, there are no intervening elements present. In addition, the terms first, second, third, etc. are used herein to describe various elements or components, these elements or components should not be limited by these terms. Consequently, a first element or component discussed below could be termed a second element or component.

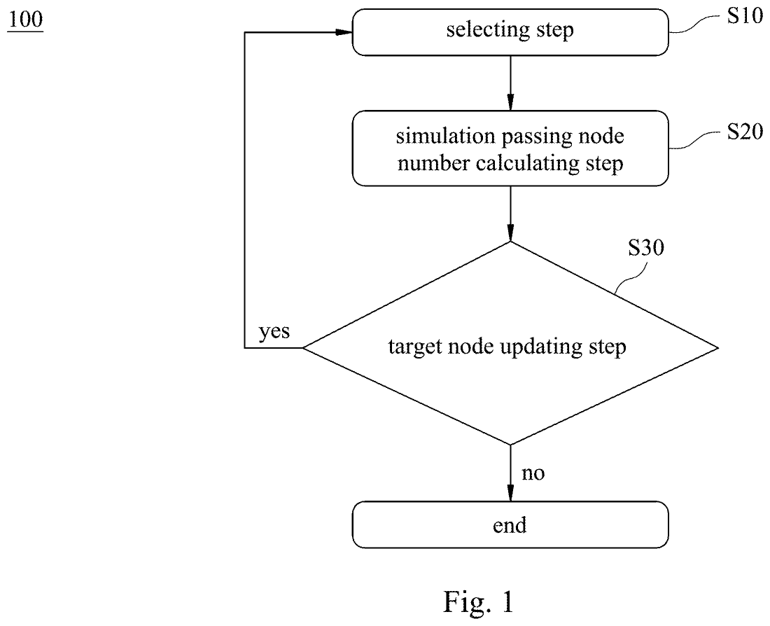

Please refer to FIG. 1. FIG. 1 shows a flow chart of a method 100 for selecting multiple target nodes within a social network according to an embodiment of the present disclosure. The method 100 for selecting multiple target nodes within the social network is performed to put a message to the target nodes in the social network to achieve a target passing node number. The method 100 for selecting multiple target nodes within the social network includes a selecting step S10, a simulation passing node number calculating step S20 and a target node updating step S30.

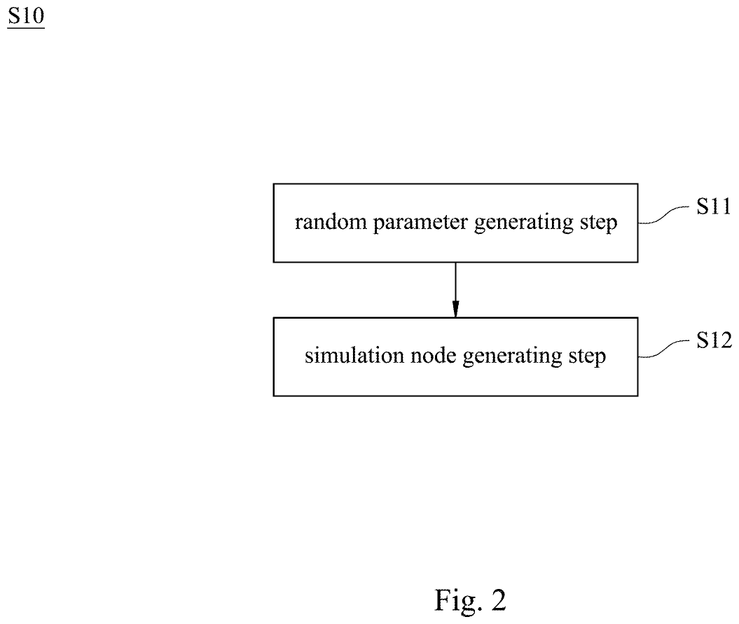

Please refer to FIG. 1 and FIG. 2. FIG. 2 shows a flow chart of the selecting step S10 of FIG. 1. The selecting step S10 is performed to select a plurality of simulation nodes from a plurality of nodes in the social network according to a simplified swarm forming rule. In detail, the selecting step S10 includes a random parameter generating step S11 and a simulation node generating step S12. The random parameter generating step S11 is performed to select a plurality of random parameters randomly. The simulation node generating step S12 is performed to compare a first parameter, a second parameter and a third parameter to the random parameters, to update the simulation nodes according to the simplified swarm forming rule. The simplified swarm forming rule is satisfied by a formula (1).

$${X}_{i , j}^{t + 1} = \{ \begin{matrix}{X}_{i , j}^{t} , if {ρ}_{i , j}^{t} ∈ [ 0 , {C}_{w} ) \\ {P}_{i , j}^{t} , if {ρ}_{i , j}^{t} ∈ [ {C}_{w} , {C}_{p} ) \\ {G}_{i , j}^{t} , if {ρ}_{i , j}^{t} ∈ [ {C}_{p} , {C}_{g} ) \\ x , if {ρ}_{i , j}^{t} ∈ [ {C}_{g} , 1 )\end{matrix} . \qquad ( 1 )$$

A j-th simulation node of an i-th group of a t-th generation is represented as X_{i,j}^{t}. A j-th random parameter of the i-th group of the t-th generation is represented as ρ_{i,j}^{t}. The first parameter, the second parameter and the third parameter are represented as C_{w}, Cₚ and C_{g}, respectively. A j-th partial passing node of the i-th group is represented as P_{i,j}^{t}. A j-th global passing node is represented as G_{i,j}^{t}. A random value is represented as x. [0,C_{w}) is represented as bigger than or equal to 0 and smaller than C_{w}. The partial passing node P_{i,j}^{t} represents the j-th simulation node of the simulation nodes corresponded to the best simulation passing node number of the i-th group between 1-th generation and the t-th generation. The global passing node G_{i,j}^{t} represents the j-th partial passing node of the partial passing nodes corresponded to the best partial passing node number between the 1-th group and the i-th group. The first parameter C_{w}, the second parameter Cₚ and the third parameter C_{g} are satisfied by a formula (2):

0<C_{w}<Cₚ<C_{g}<1 (2).

For example, when t is equal to 15, and i is equal to 3, the random parameter generated by the random parameter generating step S11 is ρ_{3,j}¹⁵. The simulation node generating step S12 is listed in the Table 1. The simulation nodes of the 3-th group of the 15-th generation are represented as X₃¹⁵, the partial passing nodes of the 3-th group of the 15-th generation are represented as P₃¹⁵, the global passing nodes of the 3-th group of the 15-th generation are represented as G_{3,j}¹⁵. The first parameter C_{w} is 0.15, the second parameter Cₚ is 0.4 and the third parameter C_{g} is 0.8. The aforementioned parameters are satisfied by a formula (3).

$${X}_{3 , j}^{16} = \{ \begin{matrix}{X}_{3 , j}^{15} , & if {ρ}_{3 , j}^{15} ∈ [ 0 , 0.15 ) \\ {P}_{3 , j}^{15} , & if {ρ}_{3 , j}^{15} ∈ [ 0.15 , 0.4 ) \\ {G}_{3 , j}^{15} , & if {ρ}_{3 , j}^{15} ∈ [ 0.4 , 0.8 ) \\ x , & if {ρ}_{i , j}^{15} ∈ [ 0.8 , 1 )\end{matrix} . \qquad ( 3 )$$

TABLE 1

| j | 1 | 2 | 3 | 4 | 5 |
|---|---|---|---|---|---|
| X_{3,j}¹⁵ | 3.2 | 2.7 | 5.5 | 2.6 | 1.5 |
| P_{3,j}¹⁵ | 3.6 | 4.7 | 2.6 | 3.8 | 4.9 |
| G_{3,j}¹⁵ | 3.4 | 1.2 | 3.0 | 5.1 | 3.7 |
| p_{3,j}¹⁵ | 0.93 | 0.57 | 0.38 | 0.03 | 0.77 |
| X_{3,j}¹⁶ | 3.3 | 1.2 | 2.6 | 2.6 | 3.7 |

In Table 1, X_{3,1}¹⁶ is 3.3, i.e., a random value x is generated from [0, 4]. (X_{3,2}¹⁶=G_{3,2}¹⁵=1.2, X_{3,3}¹⁶=P_{3,3}¹⁵=2.6, X_{3,4}¹⁶=X_{3,4}¹⁵=2.6, X_{3,5}¹⁶=G_{3,5}¹⁵=3.7, the simulation nodes X₃¹⁶ of the 3-th group of the 16-th generation are (3.3, 1.2, 2.6, 2.6, 3.7).

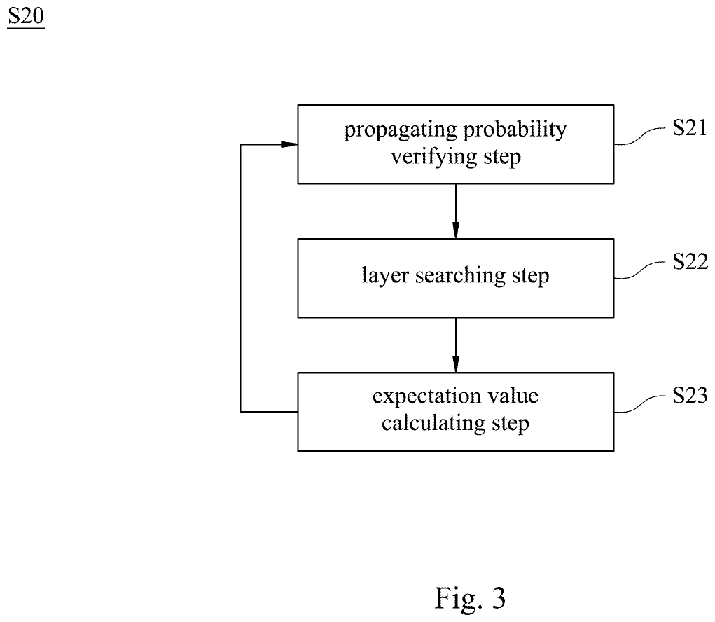

Please refer to FIG. 3. FIG. 3 shows a flow chart of the simulation passing node number calculating step S20 of FIG. 1. The simulation passing node number calculating step S20 is performed to calculate a simulation passing node number of the simulation nodes according to a Monte Carlo simulation method and a layer search method. The simulation passing node number calculating step S20 includes a propagating probability verifying step S21, a layer searching step S22 and an expectation value calculating step S23.

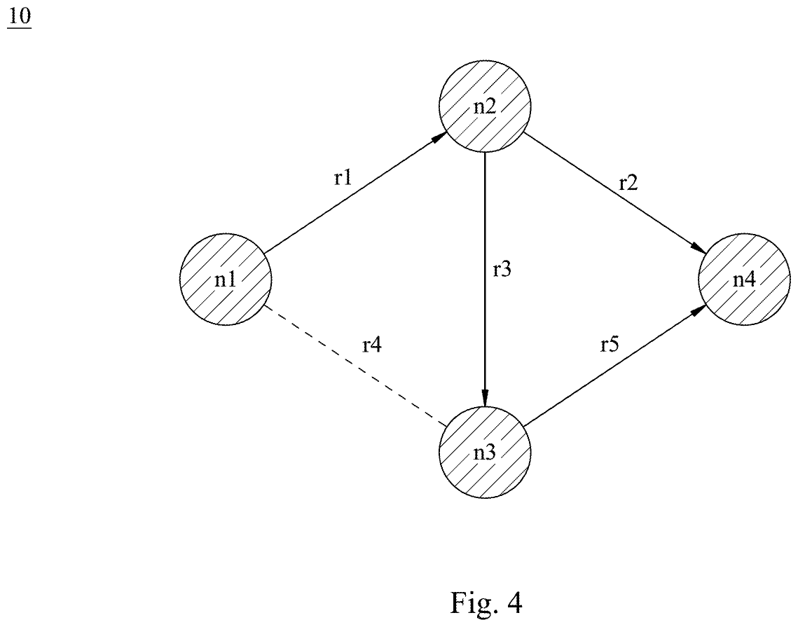

Please refer to FIG. 3 and FIG. 4. FIG. 4 shows a schematic view of a feasible passing model 10 of the propagating probability verifying step S21 of FIG. 3. The propagating probability verifying step S21 is performed to verify a propagating probability between each two of the nodes connected to each other in the social network according to the Monte Carlo simulation method, to form a feasible network model 10. The feasible network model 10 includes the propagating probability. Moreover, the social network includes the simulation nodes n1, n2 which are selected by the selecting step S10 and the nodes n3, n4. Each two of the nodes are connected to each other by one of a plurality of routes r1, r2, r3, r4 and r5. Because the social network is a scale-free network, the probabilities of the routes are different. The Monte Carlo simulation method verifies the probability of each of the route by random values, to obtain the feasible network model 10 which approaches the real condition. According to the embodiment of the present disclosure, the Monte Carlo simulation method generates a random probability corresponded to the propagating probability of each of the routes in the social network, and compares the propagating probability and the random probability of each of the routes. If the random probability is bigger than the propagating probability, the route is determined to be unfeasible. In Table 2 and FIG. 4, the propagating probability of the route r4 is smaller than the random probability, so the route r4 is unfeasible.

TABLE 2

| | r1 | r2 | r3 | r4 | r5 |
|---|---|---|---|---|---|
| propagating probability | 0.6 | 0.9 | 0.5 | 0.2 | 0.8 |
| random probability | 0.5 | 0.8 | 0.3 | 0.4 | 0.6 |

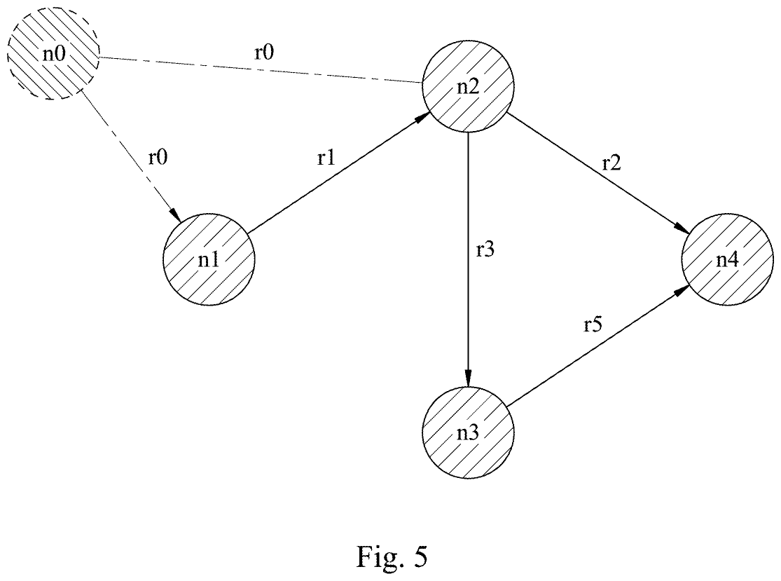

Please refer to FIG. 3 and FIG. 5. FIG. 5 shows a schematic view of the layer searching step S22 of FIG. 3. The layer searching step S22 is performed to calculate a propagating node number of the feasible network model 10 according to the layer search method. A virtual node n0 is connected to the simulation nodes n1 and n2 by a virtual routes r0, to calculate the propagating node number of putting message to simulation nodes n1, n2 in the feasible network model 10. The propagating probabilities of the virtual routes r0 are both 1. In detail, the layer searching step S22 calculates the propagating node number by counting the node number propagated to the next layer by each of the nodes in the feasible network model 10, and the calculating method of the layer searching method can be listed in Table 3.

TABLE 3

| i | Li | Li + 1 | V* | sum |
|---|---|---|---|---|
| 1 | {n0} | {n1, n2} | {n0, n1, n2} | 2 |
| 2 | {n1, n2} | {n2, n3} | {n0, n1, n2, n3} | 3 |
| 3 | {n2, n3} | {n4} | {n0, n1, n2, n3, n4} | 4 |

An i-th layer is represented as Li, an i+1-th layer is represented as Li+1, a feasible propagating node set of the virtual node n0 is represented as V*, a sum is the propagating node number, which is the node number of V* after subtracting the virtual node n0, in the present time. In Table 3, the propagating node number of the virtual node n0 in the feasible network model 10 is 4.

Please refer to Table 4, the expectation value calculating step S23 is performed to repeatedly perform the propagating probability verifying step S21 and the layer searching step S22, and count the simulation passing node number to calculate an expectation value E. Therefore, the expectation value calculating step S23 repeatedly performs the propagating probability verifying step S21 and the layer searching step S22 at least one time to count the expectation value E. The expectation value E is a simulation passing node number of putting a message to simulation nodes n1 and n2 in the feasible network model 10. When the propagating probability verifying step S21 and the layer searching step S22 are repeatedly performed 10 times, the calculating formula of the simulation passing node number is satisfied by a formula (4).

$$E = {\sum }_{i = 1}^{n} i \times \frac{{t}_{i}}{10} = \frac{10 + 4 + 3 + 4 + 4}{m} = \frac{25}{10} = 2.5 . \qquad ( 4 )$$

TABLE 4

| propagating node number(i) | times(tᵢ) | Pᵢ = tᵢ/m | i × Pᵢ |
|---|---|---|---|
| 5 | 2 | 2/10 | 2/10 |
| 4 | 1 | 2/10 | 2/10 |
| 3 | 1 | 2/10 | 2/10 |
| 2 | 2 | 2/10 | 2/10 |
| 1 | 4 | 2/10 | 2/10 |

the propagating node number is represented as i, the performing times of the propagating probability verifying step S21 is represented as m, the times of the propagating node number i when the performing time of the propagating probability verifying step S21 performing m times is represented as tᵢ, the propagating probability of the propagating node number i when the propagating probability verifying step S21 performing m times is represented as Pᵢ.

Please refer to FIG. 1. The target node updating step S30 is performed to update the simulation nodes and the simulation passing node number as the target nodes and the target passing node number according to a simplified swarm updating rule, respectively. The simplified swarm updating rule includes: in response to determining that the simulation passing node number of the simulation nodes is bigger than a partial passing node number of a plurality of partial passing nodes, the partial passing nodes and the partial passing node number are updated as the simulation nodes and the simulation passing node number, respectively. In response to determining that the partial passing node number of the partial passing nodes is bigger than a global passing node number of a plurality of global passing nodes, the global passing nodes and the global passing node number are updated as the partial passing nodes and the partial passing node number, respectively. In response to determining that the global passing node number of the global passing nodes is bigger than the target passing node number, the target nodes are updated as the global passing nodes. Moreover, the target node updating step S30 is performed to compare the simulation nodes Xⱼ^{t+1} obtained from the simulation passing node number calculating step S20 and the simulation passing node number with the partial passing nodes Pᵢ^{t}. If the simulation passing node number is bigger than the partial passing node number of the latest generation, the simulation nodes Xᵢ^{t+1} replaces the partial passing nodes Pᵢ^{t} to become a new partial passing nodes Pᵢ^{t+1}. And then, the partial passing node number of the new partial passing nodes Pᵢ^{t+1} is compared with the global passing node number of the global passing nodes G_{i,j}^{t}. If the partial passing node number of the new partial passing node Pᵢ^{t+1} is bigger than the global passing node number, the new partial passing nodes Pᵢ^{t+1} replaces the global passing nodes G_{i,j}^{t} to become a new global passing nodes G_{i,j}^{t+1}.

In detail, the target node updating step S30 is configured to judge whether the simulation passing node number of the simulation nodes Xᵢ^{t+1} obtained from the simulation passing node number calculating step S20 is achieve the target passing node number. In response to determining that the simulation passing node number is smaller than the target passing node number, the selecting step S10, the simulation passing node number calculating step S20 and the target node updating step S30 are performed again. The simulation nodes Xᵢ^{t+2} is selected, and the simulation passing node number is calculated again, and the target node updating step S30 determines whether the simulation passing node number is achieved the target passing node number. Thus, the method 100 for selecting multiple target nodes within the social network is performed to put message to less target nodes to achieve a great numerous target passing node number.

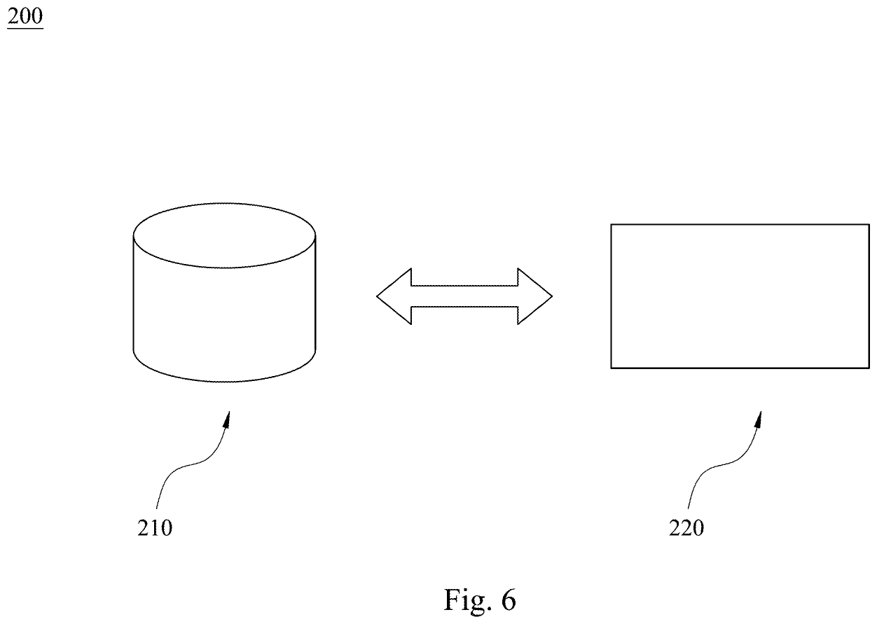

Please refer to FIG. 1, FIG. 2, FIG. 3 and FIG. 6. FIG. 6 shows a block diagram of a system 200 for selecting multiple target nodes within a social network according to another embodiment of the present disclosure. The system 200 for selecting multiple target nodes within the social network includes a memory 210 and a processor 220. The memory 210 accesses a plurality of nodes of the social network. The processor 220 is electrically connected to the memory 210, the processor 220 receives the nodes and is configured to implement the selecting step S10, the simulation passing node number calculating step S20 and the target node updating step S30 of the method 100 for selecting multiple target nodes within the social network. The memory 210 is configured to access the nodes, the simulation nodes, the simulation passing node number, the target nodes, the target passing node number, the simplified swarm forming rule, the Monte Carlo simulation method, the layer search method and the simplified swarm updating rule. The processor 220 can be a microprocessor, a computing processing unit, a server processor or other electrical processing unit, but the present disclosure is not limited thereto.

Thus, the system 200 for selecting multiple target nodes within the social network is configured to put the message to less target nodes to achieve a great numerous target passing node number.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for selecting multiple target nodes within a social network, which is configured to put a message to the target nodes in the social network to achieve a target passing node number, the method for selecting multiples target nodes within the social network comprising:
performing a selecting step to select a plurality of simulation nodes from a plurality of nodes in the social network according to a simplified swarm forming rule;
performing a simulation passing node number calculating step to calculate a simulation passing node number of the simulation nodes according to a Monte Carlo simulation method and a layer search method; and
performing a target node updating step to update the simulation nodes and the simulation passing node number as the target nodes and the target passing node number according to a simplified swarm updating rule, respectively;
wherein in response to determining that the simulation passing node number is smaller than the target passing node number, the selecting step, the simulation passing node number calculating step and the target node updating step are performed again.

2. The method for selecting the multiple target nodes within the social network of claim 1, wherein the simulation passing node number calculating step comprises:
performing a propagating probability verifying step to verify a propagating probability between each two of the nodes connected to each other in the social network according to the Monte Carlo simulation method, to form a feasible network model, wherein the feasible network model comprises the propagating probability;
performing a layer searching step to calculate a propagating node number of the feasible network model according to the layer search method; and
performing an expectation value calculating step to repeatedly perform the propagating probability verifying step and the layer searching step, and count an expectation value to calculate the simulation passing node number according to the propagating node number.

3. The method for selecting the multiple target nodes within the social network of claim 1, wherein the selecting step comprises:
performing a random parameter generating step to select a plurality of random parameters randomly;
performing a simulation node generating step to compare a first parameter, a second parameter and a third parameter to the random parameters, to update the simulation nodes according to the simplified swarm forming rule;
wherein the simplified swarm forming rule is described as follows:
$${X}_{i , j}^{t + 1} = \{ \begin{matrix}{X}_{i , j}^{t} , if {ρ}_{i , j}^{t} ∈ [ 0 , {C}_{w} ) \\ {P}_{i , j}^{t} , if {ρ}_{i , j}^{t} ∈ [ {C}_{w} , {C}_{p} ) \\ {G}_{i , j}^{t} , if {ρ}_{i , j}^{t} ∈ [ {C}_{p} , {C}_{g} ) \\ x , if {ρ}_{i , j}^{t} ∈ [ {C}_{g} , 1 )\end{matrix} ,$$
wherein a j-th simulation node of an i-th group of a t-th generation is represented as X_{i,j}^{t}, a j-th random parameter of the i-th group of the t-th generation is represented as ρ_{i,j}^{t}, the first parameter, the second parameter and the third parameter are represented as C_{w}, Cₚ and C_{g}, respectively, a j-th partial passing node of the i-th group is represented as P_{i,j}^{t}, a j-th global passing node is represented as G_{i,j}^{t}, and a random value is represented as x.

4. The method for selecting the multiple target nodes within the social network of claim 3, wherein the first parameter is C_{w}, the second parameter is Cₚ, the third parameter is C_{g}, and the first parameter, the second parameter and the third parameter are satisfied the following condition:
0<C_{w}<Cₚ<C_{g}<1.

5. The method for selecting the multiple target nodes within the social network of claim 3, wherein the simplified swarm updating rule comprises:
in response to determining that the simulation passing node number of the simulation nodes is bigger than a partial passing node number of a plurality of partial passing nodes, the partial passing nodes and the partial passing node number are updated as the simulation nodes and the simulation passing node number, respectively;
in response to determining that the partial passing node number of the partial passing nodes is bigger than a global passing node number of a plurality of global passing nodes, the global passing nodes and the global passing node number are updated as the partial passing nodes and the partial passing node number, respectively; and
in response to determining that the global passing node number of the global passing nodes is bigger than the target passing node number, the target nodes are updated as the global passing nodes.

6. A system for selecting multiple target nodes within a social network, which is configured to put a message to the target nodes in the social network to achieve a target passing node number, the system for selecting multiple target nodes within the social network comprising:
a memory accessing a plurality of nodes of the social network; and
a processor electrically connected to the memory, wherein the processor receives the nodes and is configured to implement a method for selecting multiple target nodes within the social network comprising:
performing a selecting step to select a plurality of simulation nodes from the nodes in the social network according to a simplified swarm forming rule;
performing a simulation passing node number calculating step to calculate a simulation passing node number of the simulation nodes according to a Monte Carlo simulation method and a layer search method; and
performing a target node updating step to update the simulation nodes and the simulation passing node number as the target nodes and the target passing node number according to a simplified swarm updating rule, respectively;
wherein in response to determining that the simulation passing node number is smaller than the target passing node number, the selecting step, the simulation passing node number calculating step and the target node updating step are performed again.

7. The system for selecting the multiple target nodes within the social network of claim 6, wherein the simulation passing node number calculating step comprises:
performing a propagating probability verifying step to verify a propagating probability between each two of the nodes connected to each other in the social network according to the Monte Carlo simulation method, to form a feasible network model, wherein the feasible network model comprises the propagating probability;
performing a layer searching step to calculate a propagating node number of the feasible network model according to the layer search method; and
performing an expectation value calculating step to repeatedly perform the propagating probability verifying step and the layer searching step, and count an expectation value to calculate the simulation passing node number according to the propagating node number.

8. The system for selecting the multiple target nodes within the social network of claim 6, wherein the selecting step comprises:
performing a random parameter generating step to select a plurality of random parameters randomly;
performing a simulation node generating step to compare a first parameter, a second parameter and a third parameter to the random parameters, to update the simulation nodes according to the simplified swarm forming rule;
wherein the simplified swarm forming rule is described as follows:
$${X}_{i , j}^{t + 1} = \{ \begin{matrix}{X}_{i , j}^{t} , if {ρ}_{i , j}^{t} ∈ [ 0 , {C}_{w} ) \\ {P}_{i , j}^{t} , if {ρ}_{i , j}^{t} ∈ [ {C}_{w} , {C}_{p} ) \\ {G}_{i , j}^{t} , if {ρ}_{i , j}^{t} ∈ [ {C}_{p} , {C}_{g} ) \\ x , if {ρ}_{i , j}^{t} ∈ [ {C}_{g} , 1 )\end{matrix} ,$$
wherein a j-th simulation node of an i-th group of a t-th generation is represented as X_{i,j}^{t}, a j-th random parameter of the i-th group of the t-th generation is represented as ρ_{i,j}^{t}, the first parameter, the second parameter and the third parameter are represented as C_{w}, Cₚ and C_{g}, respectively, a j-th partial passing node of the i-th group is represented as P_{i,j}^{t}, a j-th global passing node is represented as G_{i,j}^{t}, and a random value is represented as x.

9. The system for selecting the multiple target nodes within the social network of claim 8, wherein the first parameter is C_{w}, the second parameter is Cₚ, the third parameter is C_{g}, and the first parameter, the second parameter and the third parameter are satisfied the following condition:
0<C_{w}<Cₚ<C_{g}<1.

10. The system for selecting the multiple target nodes within the social network of claim 8, wherein the simplified swarm updating rule comprises:
in response to determining that the simulation passing node number of the simulation nodes is bigger than a partial passing node number of a plurality of partial passing nodes, the partial passing nodes and the partial passing node number are updated as the simulation nodes and the simulation passing node number, respectively;
in response to determining that the partial passing node number of the partial passing nodes is bigger than a global passing node number of a plurality of global passing nodes, the global passing nodes and the global passing node number are updated as the partial passing nodes and the partial passing node number, respectively; and
in response to determining that the global passing node number of the global passing nodes is bigger than the target passing node number, the target nodes are updated as the global passing nodes.
